(19) United States
(12) Patent Application Publication
(10) Pub. No.: US 2002/0108472 A1
(43) Pub. Date: Aug. 15, 2002

(54) Tool handle having weight reducing structure

(76) Inventor: Arthur Wu, Taichung Hsien (TW)

Correspondence Address: CHARLES E. BAXLEY, 5th Floor, 59 John Street, New York, NY, 10038, US

(21) Appl. No.: 09/781,115

(22) Filed: Feb. 12, 2001

(51) Int. Cl. B25B 13/00

(52) U.S. Cl. 81/177.1

(57) ABSTRACT

A tool handle includes a tool member disposed on one end and a stem extended from the other end and having a width or a height smaller than that of the handle and having an orifice. A sleeve is engaged onto the stem and includes an aperture aligned with the orifice of the stem. A fastener includes a barrel extended from one end of a blade and engaged into the aperture of the sleeve and the orifice of the stem, and includes a pin extended from the other end of the blade and engaged into the barrel for detachably securing the barrel to the stem of the handle.

### BACKGROUND OF THE INVENTION

1. Field of the Invention

The present invention relates to a tool, and more particularly to a tool handle having a weight reducing structure.

2. Description of the Prior Art

The applicant has developed a typical tool handle having a weight reducing structure and issued as U.S. Pat. No. 6,089,130 to Wu. The tool handle includes a soft or resilient covering sleeve engaged onto the diameter reduced section of the tool handle with a molding process. The covering sleeve may not be made separately from the tool handle and thus may not be easily made in mass production.

The present invention has arisen to mitigate and/or obviate the afore-described disadvantages of the conventional tool handles.

### SUMMARY OF THE INVENTION

The primary objective of the present invention is to provide a tool handle including a sleeve that may be made separately and may be made in mass production and that may be easily and quickly assembled onto the tool handle without the other fasteners.

In accordance with one aspect of the invention, there is provided a tool handle comprising a handle body including a first end having a tool member provided thereon, and including a second end having a stem extended therefrom, the stem including a width smaller than that of the handle body and including an orifice formed therein, a sleeve engaged onto the stem of the handle body and including an aperture formed therein for aligning with the orifice of the stem, and a fastener device including a blade having a first end and a second end, the blade including a barrel extended from the first end thereof for engaging into the aperture of the sleeve and the orifice of the stem, the blade including a pin extended from the second end thereof for engaging into the barrel and for detachably securing the barrel to the stem of the handle body, for allowing the sleeve to be made separately from the handle body and to be made in mass production and to be easily and quickly assembled onto the tool handle without the other fasteners.

The sleeve includes an outer peripheral portion having a recess formed therein for receiving the blade, the aperture of the sleeve is communicating with the recess of the sleeve.

The stem includes an opening formed therein, the sleeve includes a bore formed therein for receiving the stem, and includes a cylindrical member formed therein and extended through the bore of the sleeve and engaged in the opening of the stem. The sleeve includes a hole formed in the cylindrical member of the sleeve.

The barrel and the pin include a frustum-shaped mating cross section. The tool member includes a fixed jaw provided on the first end of the handle body, a movable jaw slidably disposed in the first end of the handle body and movable toward and away from the fixed jaw, and means for moving the movable jaw toward and away from the fixed jaw.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a tool handle in accordance with the present invention;

FIG. 2 is an exploded view of the tool handle;

FIG. 3 is a plane view of the tool handle;

FIG. 4 is a cross sectional view taken along lines 4-4 of FIG. 3, and

FIG. 5 is a cross sectional view taken along lines 5-5 of FIG. 4.

### DETAILED DESCRIPTION OF THE PREFERRED EMBODIMENT

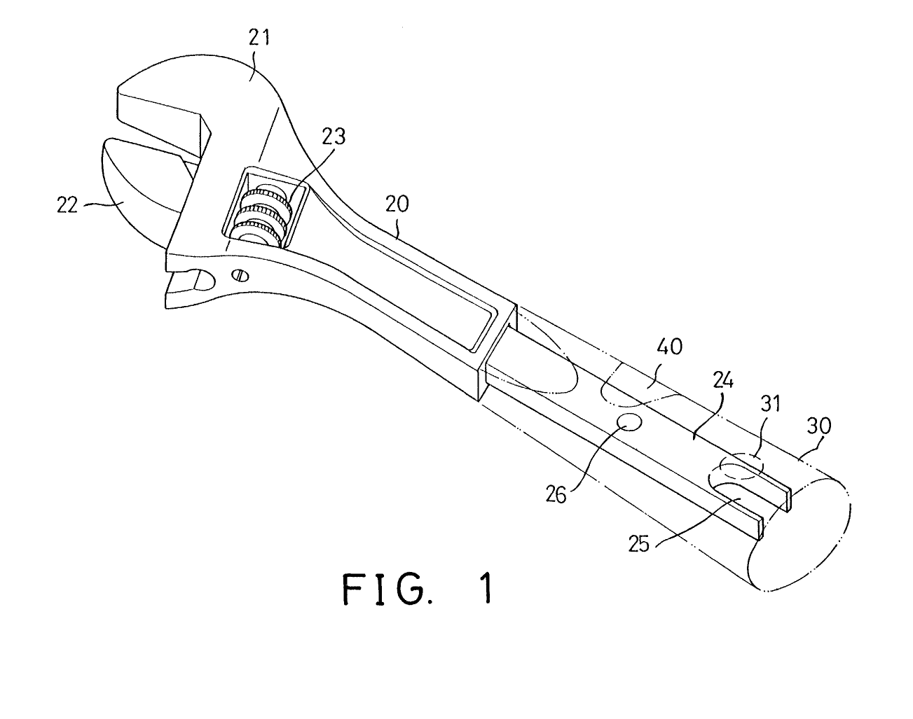

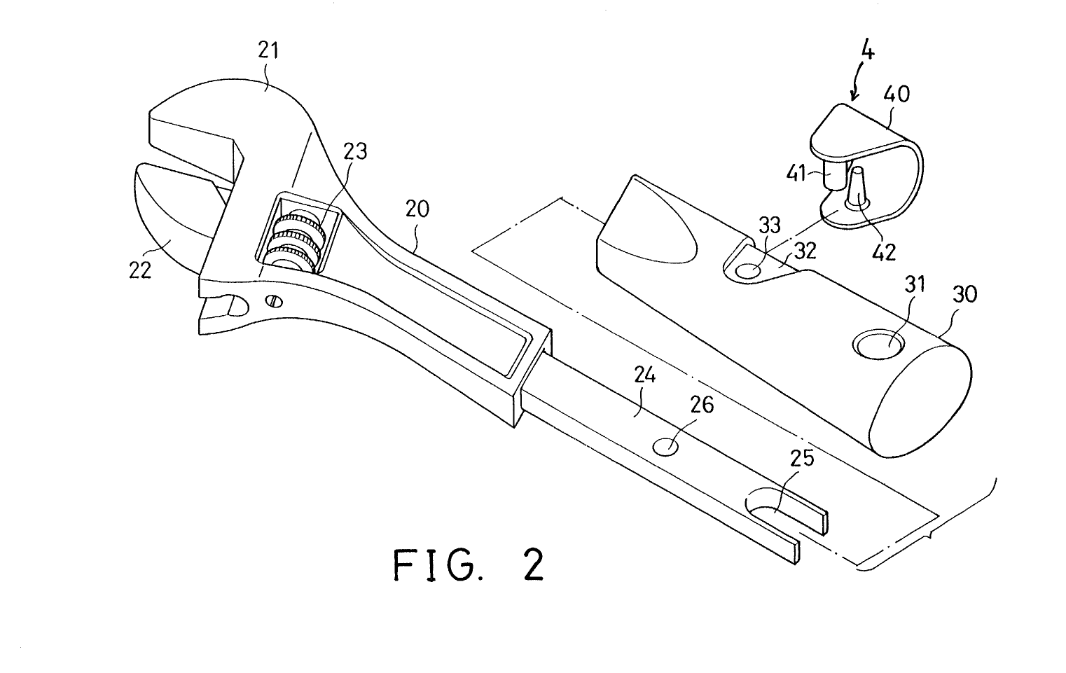

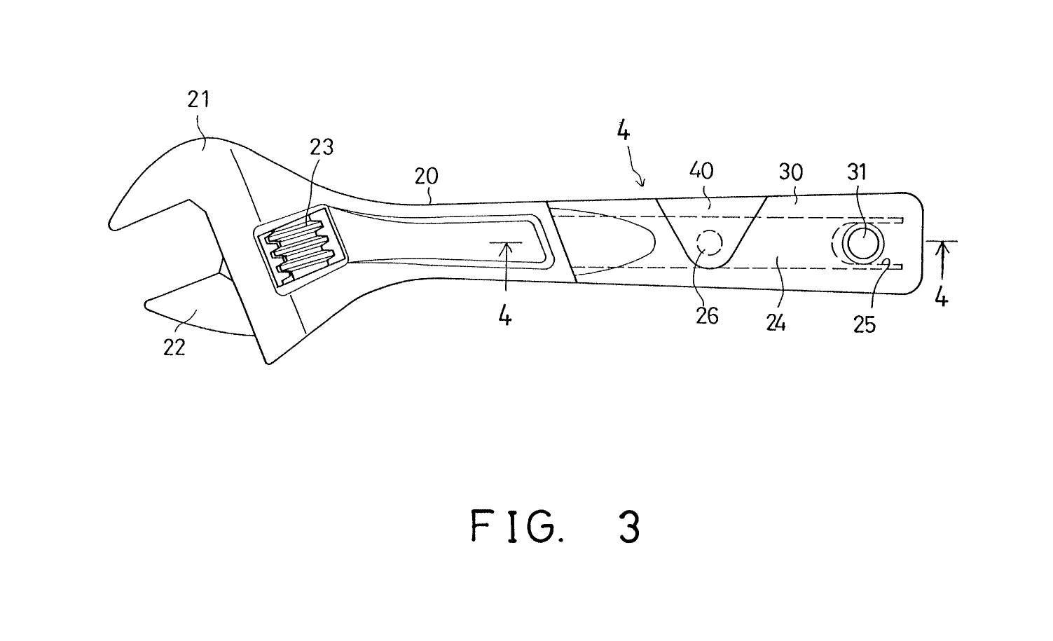

Referring to the drawings, and initially to FIGS. 1-3, a tool handle in accordance with the present invention comprises a handle body 20, and a tool member provided on one end of the handle body 20, such as an adjustable wrench which includes a fixed jaw 21 and a movable jaw 22 and an adjusting screw 23 engaged with the movable jaw 22 to move the movable jaw 22 toward and away from the fixed jaw 21. The handle body 20 includes a stem 24 extended from the other end thereof and preferably having a non-circular cross section and having a size, such as a width or a height or a cross section smaller than that of the handle body 20. The stem 24 includes an orifice 26 formed therein and includes an opening 25 formed therein, preferably formed in the free end portion thereof. The handle body 20 and the stem 24 are preferably made of metal material that has an excellent strength.

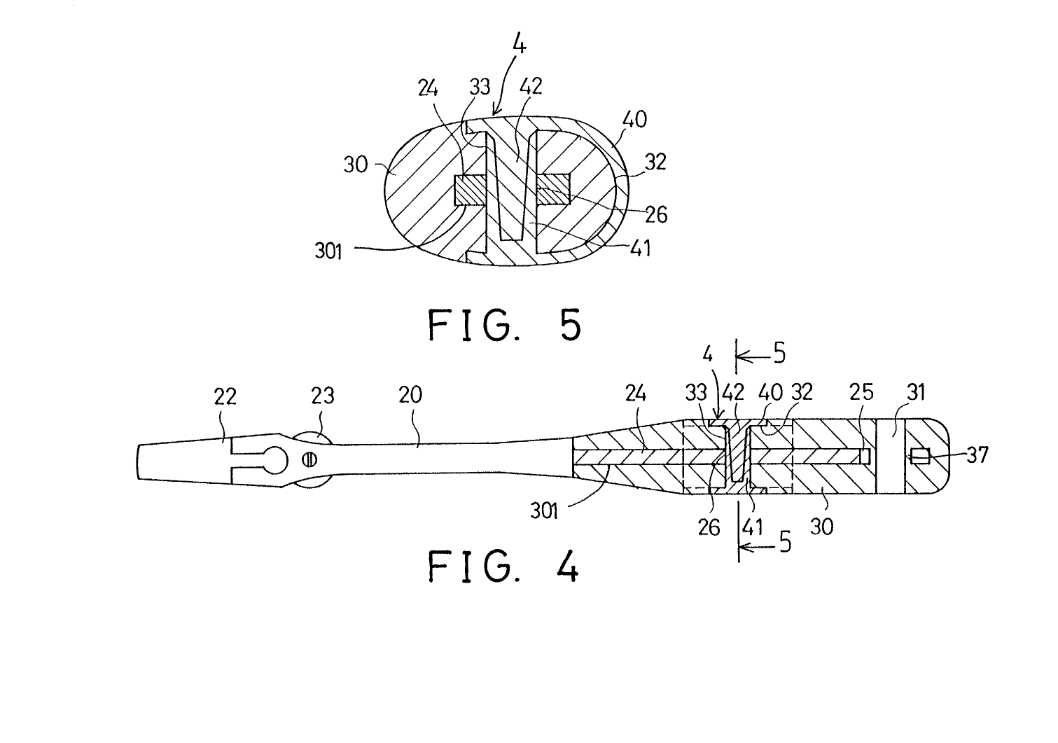

A soft or resilient sleeve 30 may be made of rubber or synthetic materials and may be made, in mass production, separately from the handle body 20 and may then be assembled onto the stem 24 of the handle body 20. The sleeve 30 includes a bore 301 (FIGS. 4, 5) formed therein for receiving the stem 24 of the handle body 20, and includes a hole 31 formed therein, and includes a cylindrical member 37 (FIG. 4) formed therein and extended through the bore 301 thereof and engaged in the opening 25 of the stem 24 and having the hole 31 formed therein. The sleeve 30 includes a recess 32 formed in the middle of the outer peripheral portion thereof and preferably formed in the upper and one side portion and the bottom portion of the sleeve 30. The sleeve 30 includes an aperture 33 formed in the middle portion and communicating with the recess 32 of the sleeve 30 and aligned with the orifice 26 of the stem 24 when the cylindrical member 37 of the sleeve 30 is engaged in the opening 25 of the stem 24.

A securing device 4 includes a C-shaped blade 40 engaged in the recess 32 of the sleeve 30, a barrel 41 extended from one end of the blade 40 for engaging into the aperture 33 of the sleeve 30 and the orifice 26 of the stem 24 (FIGS. 4, 5), and a pin 42 extended from the other end of the blade 40 for engaging into the aperture 33 of the sleeve 30 and for engaging into the barrel 41 and for securing to the barrel 41 with such as a force-fitted engagement. The pin 42 preferably includes a frustum-shaped cross section (FIGS. 4, 5) for engaging with a cavity of the barrel 41 that has a corresponding frustum-shaped cross section. The securing device 4 may be made of metal, plastic or the other materials that have a suitable anti-bending strength or the like, for stably and solidly securing the sleeve 30 to the stem 24 of the handle body 20. The barrel 41 may be suitably deformed to solidly securing the pin 42 in the barrel 41 after the pin 42 is forced and engaged into the barrel 41. An adhesive material may further be engaged into the barrel 41 for further solidly securing the pin 42 within the barrel 41.

It is to be noted that the sleeve may be made separately and may be made in mass production and may be easily and quickly assembled onto the sleeve and the handle body without additional tool members or fasteners. The other sleeves of different colors or shapes may be selectively and changeably engaged onto the stem and may be replaced with each other.

Accordingly, the tool handle in accordance with the present invention includes a sleeve that may be made separately and may be made in mass production and that may be easily and quickly assembled onto the tool handle without the other fasteners.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool handle comprising:
a handle body including a first end having a tool member provided thereon, and including a second end having a stem extended therefrom, said stem including a width smaller than that of said handle body and including an orifice formed therein,
a sleeve engaged onto said stem of said handle body and including an aperture formed therein for aligning with said orifice of said stem, and
a fastener device including a blade having a first end and a second end, said blade including a barrel extended from said first end thereof for engaging into said aperture of said sleeve and said orifice of said stem, said blade including a pin extended from said second end thereof for engaging into said barrel and for securing said barrel to said stem of said handle body.

2. The tool handle according to claim 1, wherein said sleeve includes an outer peripheral portion having a recess formed therein for receiving said blade, said aperture of said sleeve is communicating with said recess of said sleeve.

3. The tool handle according to claim 1, wherein said stem includes an opening formed therein, said sleeve includes a bore formed therein for receiving said stem, and includes a cylindrical member formed therein and extended through said bore of said sleeve and engaged in said opening of said stem.

4. The tool handle according to claim 3, wherein said sleeve includes a hole formed in said cylindrical member of said sleeve.

5. The tool handle according to claim 1, wherein said barrel and said pin include a frustum-shaped mating cross section.

6. The tool handle according to claim 1, wherein said tool member includes a fixed jaw provided on said first end of said handle body, a movable jaw slidably disposed in said first end of said handle body and movable toward and away from said fixed jaw, and means for moving said movable jaw toward and away from said fixed jaw.

7. A tool handle comprising:
a handle body including a first end having a tool member provided thereon, and including a second end having a stem extended therefrom, said stem including a height smaller than that of said handle body and including an orifice formed therein,
a sleeve engaged onto said stem of said handle body and including an aperture formed therein for aligning with said orifice of said stem, and
a fastener device including a blade having a first end and a second end, said blade including a barrel extended from said first end thereof for engaging into said aperture of said sleeve and said orifice of said stem, said blade including a pin extended from said second end thereof for engaging into said barrel and for securing said barrel to said stem of said handle body.

8. A tool handle comprising:
a handle body including a first end having a tool member provided thereon, and including a second end having a stem extended therefrom, said stem including a cross section smaller than that of said handle body and including an orifice formed therein,
a sleeve engaged onto said stem of said handle body and including an aperture formed therein for aligning with said orifice of said stem, and
a fastener device including a blade having a first end and a second end, said blade including a barrel extended from said first end thereof for engaging into said aperture of said sleeve and said orifice of said stem, said blade including a pin extended from said second end thereof for engaging into said barrel and for securing said barrel to said stem of said handle body.
